(19) United States
(12) Patent Application Publication
(10) Pub. No.: US 2024/0166780 A1
(43) Pub. Date: May 23, 2024

(54) PROCESS FOR MAKING POLYPROPYLENE USING A SELECTIVITY CONTROL AGENT AND AN ACTIVITY LIMITING AGENT

(71) Applicant: SABIC GLOBAL TECHNOLOGIES B.V., BERGEN OP ZOOM (NL)

(72) Inventors: Martin Alexander Zuideveld, Kelmis (BE); Henrica Norberta Alberta Maria Steenbakkers-Menting, Susteren (NL); Sang Yull Kim, Riyadh (SA); Marios Lagoidis, Limburg (NL)

(21) Appl. No.: 18/284,319

(22) PCT Filed: Mar. 31, 2022
(86) PCT No.: PCT/EP2022/058521

§ 371 Date: Sep. 27, 2023

(30) Foreign Application Priority Data
Apr. 1, 2021 (EP) 21166566.6

(51) Int. Cl. C08F 110/06

(52) U.S. Cl. CPC C08F 110/06

(57) ABSTRACT

A process for the production of a propylene homopolymer or a propylene-ethylene copolymer includes polymerizing propylene and optional ethylene comonomers in the presence of a catalyst, wherein the catalyst is obtainable by a process of A) providing a Ziegler-Natta procatalyst including contacting a magnesium-containing support with i) a halogen-containing titanium compound, ii) ethylbenzoate as an activator, iii) and as internal donor an aminobenzoate compound according to formula B

preferably 4-[benzoyl(methyl)amino]pentan-2-yl benzoate (AB); and B) contacting the Ziegler-Natta procatalyst obtained in step A) with a co-catalyst and a Selectivity Control Agent (SCA) in combination with an Activity Limiting Agent (ALA) to obtain the catalyst.

### CROSS REFERENCE TO RELATED APPLICATIONS

This application is a National Stage application of PCT/EP2022/058521, filed Mar. 31, 2022, which claims the benefit of European Application No. 21166566.6, filed Apr. 1, 2021, both of which are incorporated by reference in their entirety herein.

### BACKGROUND

The invention relates to a process for the production of propylene homopolymer or propylene-ethylene copolymer.

Processes for the production of a propylene homopolymer or a propylene-ethylene copolymer are known to the person skilled in the art. Polypropylene homopolymers and propylene-ethylene copolymers can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

An example of a process for the production of a propylene homopolymer or a propylene-ethylene copolymer is described in WO2018069541A1. WO2018069541A1 discloses a process for the production of a propylene homopolymer or a propylene-ethylene copolymer comprising the step of polymerizing propylene and optional ethylene comonomers in the presence of a catalyst to obtain the propylene homopolymer or the propylene-ethylene copolymer, wherein said catalyst is obtainable by a process comprising the steps of
A) providing a Ziegler-Natta procatalyst comprising contacting a magnesium-containing support with
   i) a halogen-containing titanium compound,
   ii) ethylbenzoate as an activator,
   iii) and as internal donor an aminobenzoate compound according to formula B:

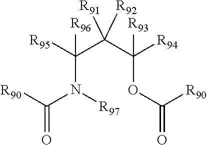

wherein each R⁹⁰ group is independently a substituted or unsubstituted aromatic group; R⁹¹, R⁹², R⁹³, R⁹⁴, R⁹⁵, and R⁹⁶ are each independently selected from a hydrogen or a linear, branched or cyclic hydrocarbyl group, selected from alkyl, alkenyl, aryl, aralkyl, or alkylaryl groups, and one or more combinations thereof, preferably having from 1 to 20 carbon atoms; R⁹⁷ is a hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; N is a nitrogen atom; O is an oxygen atom; and C is a carbon atom; preferably 4-[benzoyl(methyl)amino]pentan-2-yl benzoate (AB); and
B) contacting said Ziegler-Natta procatalyst obtained in step A) with a co-catalyst and di(isopropyl) dimethoxysilane as external electron donor to obtain said catalyst;
preferably wherein step A) to provide the Ziegler-Natta procatalyst comprises the following steps:
   i) contacting a compound R⁴_{z}MgX⁴_{2-z} with an alkoxy- or aryloxy-containing silane compound to give a first intermediate reaction product, being a solid Mg(OR¹)ₓX¹₂₋ₓ, wherein: R⁴ and R¹ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; X⁴ and X¹ are each independently selected from the group of consisting of fluoride (F−), chloride (Cl−), bromide (Br−) or iodide (I−), preferably chloride; z is in a range of larger than 0 and smaller than 2, being 0<z<2, x is in a range of larger than 0 and smaller than 2, being 0<x<2;
   ii) optionally contacting the solid Mg(OR¹)ₓX¹₂₋ₓ obtained in step ii) with at least one activating compound selected from the group formed of activating electron donors and metal alkoxide compounds of formula M¹(OR²)_{v-w}(OR³)_{w} or M²(OR²)_{v-w}(R³)_{w}, to obtain a second intermediate product; wherein M¹ is a metal selected from the group consisting of Ti, Zr, Hf, Al or Si; M² is a metal being Si; v is the valency of M¹ or M² and is either 3 or 4; w<v; R² and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms;
   iii) contacting the first or second intermediate reaction product, obtained respectively in step i) or ii), with the halogen-containing Ti-compound; the activator; and the internal electron donor
   to obtain said Ziegler-Natta procatalyst;

However, when producing propylene homopolymers or propylene-ethylene copolymer having an XS in the range from 2.0 to 7.0 wt %, wherein XS stands for the amount of xylene soluble which are measured according to ASTM D 5492-10, the polymerization rate increases steeply with temperature, in particular when using an amidobenzoate comprising catalyst. Such steep increases in temperature can lead to temperature spikes in the reactor, especially at locations where the polypropylene power is relatively static (i.e. does not move) and/or where cooling is less efficient. This may lead to accumulation of powder on thermocouples, which then may not provide an accurate registration of the temperature. An inaccurate temperature registration in its turn will lead to an inaccurate, or even an inadequate cooling of the reactor. In case the reactor temperatures are not adequately controlled, this increases the risk of lump formation in the reactor, the presence of liquid propylene in the reactor, which present potential safety hazards.

### SUMMARY

Therefore, it is the object of the invention to provide a process for the production of propylene homopolymers or propylene-ethylene copolymer having an XS in the range from 2.0 to 7.0 wt %, wherein XS stands for the amount of xylene solubles which are measured according to ASTM D 5492-10, and using an amidovenzoate comprising catalyst, wherein the steepness of the polymerization rate with temperature is decreased.

This object is achieved by a process for the production of a propylene homopolymer or a propylene-ethylene copolymer wherein the propylene homopolymer or the propylene-ethylene copolymer has an XS in the range from 2.0 to 7.0 wt %, wherein XS stands for the amount of xylene solubles which are measured according to ASTM D 5492-10 comprising the step of polymerizing propylene and optional ethylene comonomers in the presence of a catalyst to obtain the propylene homopolymer or the propylene-ethylene copolymer, wherein said catalyst is obtainable by a process comprising the steps of
A) providing a Ziegler-Natta procatalyst comprising contacting a magnesium-containing support with
   i) a halogen-containing titanium compound,
   ii) ethylbenzoate as an activator,
   iii) and as internal donor an aminobenzoate compound according to formula B:

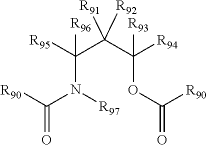

wherein each R⁹⁰ group is independently a substituted or unsubstituted aromatic group; R⁹¹, R⁹², R⁹³, R⁹⁴, R⁹⁵, and R⁹⁶ are each independently selected from a hydrogen or a linear, branched or cyclic hydrocarbyl group, selected from alkyl, alkenyl, aryl, aralkyl, or alkylaryl groups, and one or more combinations thereof, preferably having from 1 to 20 carbon atoms; R⁹⁷ is a hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; N is a nitrogen atom; O is an oxygen atom; and C is a carbon atom; preferably 4-[benzoyl(methyl)amino]pentan-2-yl benzoate (AB); and
B) contacting said Ziegler-Natta procatalyst obtained in step A) with a co-catalyst and a Selectivity Control Agent (SCA) in combination with an Activity Limiting Agent (ALA) to obtain said catalyst;
preferably wherein step A) to provide the Ziegler-Natta procatalyst comprises the following steps:
   i) contacting a compound R⁴_{z}MgX⁴_{2-z} with an alkoxy- or aryloxy-containing silane compound to give a first intermediate reaction product, being a solid Mg(OR¹)X¹₂₋ₓ, wherein: R⁴ and R¹ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; X⁴ and X¹ are each independently selected from the group of consisting of fluoride (F−), chloride (Cl−), bromide (Br−) or iodide (I−), preferably chloride; z is in a range of larger than 0 and smaller than 2, being 0<z<2, x is in a range of larger than 0 and smaller than 2, being 0<x<2;
   ii) optionally contacting the solid Mg(OR¹)ₓX¹₂₋ₓ obtained in step ii) with at least one activating compound selected from the group formed of activating electron donors and metal alkoxide compounds of formula M¹(OR²)_{v-w}(OR³)_{w} or M²(OR²)_{v-w}(R³)_{w}, to obtain a second intermediate product; wherein M¹ is a metal selected from the group consisting of Ti, Zr, Hf, Al or Si; M² is a metal being Si; v is the valency of M¹ or M² and is either 3 or 4; w<v; R² and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms;
   iii) contacting the first or second intermediate reaction product, obtained respectively in step i) or ii), with the halogen-containing Ti-compound; the activator; and the internal electron donor
   to obtain said Ziegler-Natta procatalyst.

### DETAILED DESCRIPTION

It was found that with said process, the steepness of the temperature of the polymerization rate can be adequately controlled, such that the accumulation of powder which may eventually give rise to lump formation and potentially hazardous situations can be prevented.

The ethylene content in the propylene-ethylene copolymer is preferably relatively low, i.e. at most 1.0 wt % based on the propylene-ethylene copolymer. For example the ethylene content is at least 0.1 wt %, for example at least 0.2 wt %, for example at least 0.3 wt %, for example at least 0.4 wt %, for example at least 0.5 wt % and/or for example at most 1.0 wt %, for example at most 0.7 wt % based on the propylene-ethylene copolymer. Within the framework of the invention, with propylene-ethylene copolymer is meant a random propylene-ethylene copolymer.

For example, the propylene homopolymer or propylene-ethylene copolymer produced in the process of the invention has an XS range of at least 2.0 wt or for example at least 2.5 wt %, for example of at least 3.0 wt. %, for example of at least 3.5%, for example of at least 4.0%. XS stands for the amount of xylene solubles which are measured according to ASTM D 5492-10. For example, the propylene homopolymer or propylene-ethylene copolymer produced in the process of the invention has an XS of at most 6.5, for example of at most 6.0 wt % based on the propylene homopolymer or the propylene-ethylene copolymer.

The propylene homopolymer or propylene-ethylene copolymer of the invention may have a melt flow rate in the range of 1 to 10 dg/min, for example a melt flow rate of at least 2 dg/min and/or at most 8 dg/min, for example at most 6 dg/min as measured according to ISO1133 (2.16 kg/230° C.). For example the propylene homopolymer or propylene-ethylene copolymer of the invention has a melt flow rate in the range 0.5 to 10 dg/min as measured according to ISO1133 (2.16 kg/230° C.).

The polypropylene homopolymer and/or propylene-ethylene copolymer may suitably be used for applications, such as for flexible packaging (film (e.g. BOPP film)), for thermoforming or for injection molding).

Process according to the invention for the production of a propylene homopolymer or a propylene-ethylene copolymer wherein the propylene homopolymer or the propylene-ethylene copolymer has an XS in the range from 2.0 to 7.0 wt %, wherein XS stands for the amount of xylene soluble which are measured according to ASTM D 5492-10 comprising the step of polymerizing propylene and optional ethylene comonomers in the presence of a catalyst system comprising a least:
A procatalyst
An activator
An internal electron donor
Optionally a co-catalyst
An external Donor comprising Selectivity Control Agent (SCA) and Activity Limiting Agent (ALA).

Preferably, the process of the invention is a gas phase polymerization process.

Preferably, the process of the invention is performed in at least one horizontal and/or vertical gas phase reactor. Such reactor may contain mechanical stirring.

Procatalyst

The procatalyst is a Ziegler-Natta type produced according to the following step.
i) contacting a compound R⁴_{z}MgX⁴_{2-z} with an alkoxy- or aryloxy-containing silane compound to give a first intermediate reaction product, being a solid Mg(OR¹)X¹₂₋ₓ, wherein: R⁴ and R¹ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; X⁴ and X¹ are each independently selected from the group of consisting of fluoride (F−), chloride (Cl−), bromide (Br−) or iodide (I−), preferably chloride; z is in a range of larger than 0 and smaller than 2, being 0<z<2, x is in a range of larger than 0 and smaller than 2, being 0<x<2;
ii) optionally contacting the solid Mg(OR¹)ₓX¹₂₋ₓ obtained in step ii) with at least one activating compound selected from the group formed of activating electron donors and metal alkoxide compounds of formula M¹(OR²)_{v-w}(OR³)_{w} or M²(OR²)_{v-w}(R³)_{w}, to obtain a second intermediate product; wherein M¹ is a metal selected from the group consisting of Ti, Zr, Hf, Al or Si; M² is a metal being Si; v is the valency of M¹ or M² and is either 3 or 4; w<v; R² and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms;
iii) contacting the first or second intermediate reaction product, obtained respectively in step i) or ii), with the halogen-containing Ti-compound; an activator; and an internal electron donor.

Activator

The activator is preferably ethylbenzoate

Internal Electron Donor

The internal electron donor is preferably an aminobenzoate compound according to formula B:

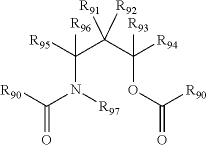

wherein each R⁹⁰ group is independently a substituted or unsubstituted aromatic group; R⁹¹, R⁹², R⁹³, R⁹⁴, R⁹⁵, and R⁹⁶ are each independently selected from a hydrogen or a linear, branched or cyclic hydrocarbyl group, selected from alkyl, alkenyl, aryl, aralkyl, or alkylaryl groups, and one or more combinations thereof, preferably having from 1 to 20 carbon atoms; R⁹⁷ is a hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; N is a nitrogen atom; O is an oxygen atom; and C is a carbon atom; preferably 4-[benzoyl(methyl)amino]pentan-2-yl benzoate (AB).

Preferably, according to the invention, the catalyst system is phthalate free. It is preferred to use so-called phthalate free internal donors because of increasingly stricter government regulations about the maximum phthalate content of polymers. In the context of the present invention, ““phthalate-free” means having a phthalate content of less than for example 150 ppm, alternatively less than for example 100 ppm, alternatively less than for example 50 ppm, alternatively for example less than 20 ppm, for example of 0 ppm based on the total weight of the catalyst system. Examples of phthalates include but are not limited to a dialkylphthalate esters in which the alkyl group contains from about two to about ten carbon atoms. Examples of phthalate esters include but are not limited to diisobutylphthalate, ethylbutylphthalate, diethylphthalate, di-n-butylphthalate, bis(2-ethylhexyl)phthalate, and diisodecylphthalate.

Therefore, preferably, the process of the invention is essentially phthalate free.

Co-Catalyst

The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst represented by the formula R²⁰₃Al.

R²⁰ is independently selected from a hydrogen or a hydrocarbyl, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. On the proviso that at least one R²⁰ is a hydrocarbyl group. Optionally, two or three R²⁰ groups are joined in a cyclic radical forming a heterocyclic structure.

Non-limiting examples of suitable R20 groups are: methyl, ethyl, propyl, isopropyl, butyl, isobutyl, tert-butyl, pentyl, neopentyl, hexyl, 2-methylpentyl, heptyl, octyl, isooctyl, 2-ethylhexyl, 5,5-dimethylhexyl, nonyl, decyl, isodecyl, undecyl, dodecyl, phenyl, phenethyl, methoxyphenyl, benzyl, tolyl, xylyl, naphthyl, methylnapthyl, cyclohexyl, cycloheptyl, and cyclooctyl.

Suitable examples of the hydrocarbyl aluminum compounds as co-catalyst include triisobutylaluminum, trihexylaluminum, di-isobutylaluminum hydride, dihexylaluminum hydride, isobutylaluminum dihydride, hexylaluminum dihydride, diisobutylhexylaluminum, isobutyl dihexylaluminum, trimethylaluminum, triethylaluminum, tripropylaluminum, triisopropylaluminum, tri-n-butylaluminum, trioctylaluminum, tridecylaluminum, tridodecylaluminum, tribenzylaluminum, triphenylaluminum, trinaphthylaluminum, and tritolylaluminum. In an embodiment, the cocatalyst is selected from triethylaluminum, triisobutylaluminum, trihexylaluminum, di-isobutylaluminum hydride and dihexylaluminum hydride. More preferably, trimethylaluminium, triethylaluminium, triisobutylaluminium, and/or trioctylaluminium. Most preferably, triethylaluminium (abbreviated as TEAL).

Preferably, the co-catalyst is triethylaluminum. The molar ratio of aluminum to titanium may be from about 5:1 to about 500:1 or from about 10:1 to about 200:1 or from about 15:1 to about 150:1 or from about 20:1 to about 100:1. The molar ratio of aluminum to titanium is preferably about 45:1.

For example, the molar ratio of aluminium to titanium, when the co-catalyst is triethylaluminium (Al/Ti ratio) ranges from 25 to 250.

In an embodiment, the process includes contacting the olefin with a co-catalyst. The co-catalyst can be mixed with the procatalyst (pre-mix) prior to the introduction of the procatalyst into the polymerization reactor. The co-catalyst may be also added to the polymerization reactor independently of the procatalyst. The independent introduction of the co-catalyst into the polymerization reactor can occur (substantially) simultaneously with the procatalyst feed. An external donor may also be present during the polymerization process.

External Donor

An external electron donor may also be present in the catalyst system according to the present invention. One of the functions of an external donor compound is to affect the stereoselectivity of the catalyst system in polymerization of olefins having three or more carbon atoms.

In the invention, the external donor is a combination of Selectivity Control Agent (SCA) and Activity Limiting Agent (ALA).

Preferably, the external donor or Selectivity Control Agent (SCA) is selected from the group consisting of: dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, n-propyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, di(isopropyl) dimethoxysilane, and bis(perhydroisoquinolino)dimethoxysilane, more preferably the SCA is selected from the group consisting of di(isopropyl) dimethoxysilane and n-propyltrimethoxysilane. For example, the external donor in the catalyst system according to the present invention may be complexed with the co-catalyst and mixed with the procatalyst (pre-mix) prior to contact between the procatalyst and the olefin. The external donor can also be added independently to the polymerization reactor. The procatalyst, the co-catalyst, and the external donor can be mixed or otherwise combined prior to addition to the polymerization reactor.

Preferably, the Activity Limiting Agent (ALA) is selected from the group consisting of: ethyl acetate, ethyl benzoate, p-ethoxy ethyl benzoate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof. More preferably, the Activity Limiting Agent (ALA) is isopropyl myristate.

The ratio of Selectivity Control Agent (SCA) to Activity Limiting Agent (ALA) is in principle not critical, best results are obtained for a SCA/ALA ratio in the range from 0.010 to 100, more preferably in the range from 0.10 to 20.

In case a phthalate-free catalyst, such as the described catalyst using a phthalate free internal/external donor, is used, the propylene homopolymer or propylene-ethylene copolymer obtainable by or obtained by the process of the invention is essentially phthalate-free. This is advantageous as more and more consumers try to avoid any contact with phthalates.

Therefore, preferably, the propylene homopolymer, propylene-ethylene copolymer or the composition of the invention, the BOPP film of the invention and/or the article of the invention are essentially phthalate-free.

Preferably, the catalyst is a 9,9-bis(methoxymethyl)fluorene (BMMF) free catalyst.

Therefore, preferably the process of the invention is essentially BMMF-free.

For purpose of the invention, essentially BMMF-free is defined as the presence of less than 0.0001 wt % of BMMF, preferably 0.00001 wt % of BMMF in the process of the invention

In another aspect, the invention relates to a propylene homopolymer or propylene-ethylene copolymer obtained or obtainable by the process of the invention.

In yet another aspect, the invention relates to a biaxially oriented polypropylene (BOPP) film comprising the propylene homopolymer or propylene-ethylene copolymer of the invention.

In yet another aspect, the invention relates to the use of the propylene homopolymer or propylene-ethylene copolymer obtained or obtainable by the process of the invention for the preparation of an article, for example for the preparation of a biaxially oriented polypropylene (BOPP) film.

In yet another aspect, the invention relates to a process for the preparation of a biaxially oriented polypropylene (BOPP) film, comprising the steps of (a) providing the propylene homopolymer and/or the propylene-ethylene copolymer of the invention and, b) stretching the propylene homopolymer and/or the propylene-ethylene copolymer of step a) in machine direction (MD) and transverse direction (TD).

Although the invention has been described in detail for purposes of illustration, it is understood that such detail is solely for that purpose and variations can be made therein by those skilled in the art without departing from the spirit and scope of the invention as defined in the claims.

It is further noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

Preparation of the Catalyst

Step A) Butyl Grignard Formation

A 1.7 L stirred flask, fitted with a reflux condenser and a funnel, was filled with magnesium powder (40.0 g, 1.65 mol). The flask was brought under nitrogen. The magnesium was dried at 80° C. for 2 hours under nitrogen purge, after which dibutyl ether (200 ml), iodine (0.05 g) and n-chlorobutane (10 ml) were successively added and stirred at 120 rpm. The temperature was maintained at 80° C. and a mixture of n-chlorobutane (146 ml) and dibutyl ether (1180 ml) was slowly added over 3 hours. The reaction mixture was stirred for another 3 hours at 80° C. Then the stirring and heating were stopped and the small amount of solid material was allowed to settle for 24 hours. By decanting the colourless solution above the precipitate, a solution of butylmagnesiumchloride with a concentration of 0.90 mol Mg/L was obtained.

Step B) Preparation of the First Intermediate Reaction Product

The solution of reaction product of step A (500 ml, 0.45 mol Mg) and 260 ml of a solution of tetraethoxysilane (TES) in dibutyl ether (DBE), (47 ml of TES and 213 ml of DBE), were cooled to 5° C., and then were fed simultaneously to a mixing device (minimixer) of 0.45 ml volume equipped with a stirrer and jacket. The minimixer was cooled to 5° C. by means of cold water circulating in the minimixer's jacket. The stirring speed in the minimixer was 1000 rpm. From the mixing device, the mixed components were directly dosed into a 1.3 liter reactor fitted with blade stirrer and containing 350 ml of dibutyl ether. The dosing temperature of the reactor was 35° C. and the dosing time was 360 min. The stirring speed in the reactor was 250 rpm at the beginning of dosing and was gradually increased up to 450 rpm at the end of dosing stage. On completion of the dosing, the reaction mixture was heated up to 60° C. in 30 minutes and held at this temperature for 1 hour. Then the stirring was stopped and the solid substance was allowed to settle. The supernatant was removed by decanting. The solid substance was washed three times using with 700 ml of heptane at a reactor temperature of 50° C. for three times. A pale yellow solid substance, reaction product B (the solid first intermediate reaction product; the support), was obtained upon drying with a nitrogen purge. The average particle size of support was 20 microns.

Step C) Preparation of the Second Intermediate Reaction Product

In inert nitrogen atmosphere at 20° C. in a 1000 ml glass flask equipped with a mechanical agitator was filled with 50 g of reaction product B, dispersed in 500 ml of heptane and stirred at 250 rpm. Subsequently, a solution of 2.7 ml ethanol (EtOH/Mg=0.1) in 20 ml heptane was dosed under stirring during 1 hour. After keeping the reaction mixture at 20° C. for 30 minutes, a solution of 9.5 ml titanium tetraethoxide (TET/Mg=0.1) in 20 ml of heptane was added for 1 hour. The slurry was slowly allowed to warm up to 30° C. over 30 minutes and held at that temperature for another 2 hours. Finally, the supernatant liquid was decanted from the solid reaction product (the second intermediate reaction product C; first activated support) which was washed once with 500 ml of heptane at 30° C. and dried using a nitrogen purge.

Step D) Preparation of the Third Intermediate Reaction Product

In inert nitrogen atmosphere at 25° C. in a 1000 ml glass flask equipped with a mechanical agitator was filled with 50 g of second intermediate reaction product C dispersed in 500 ml of heptane and stirred at 250 rpm. Subsequently, a solution of 6.3 ml ethanol (EtOH/Mg=0.3), 20.8 ml of toluene and 37.5 ml of heptane was dosed at 25° C. under stirring during 1 hour. The slurry was slowly allowed to warm up to 30° C. over 30 minutes and held at that temperature for another 3 hours. Finally, the supernatant liquid was decanted from the solid reaction product (the third intermediate reaction product D; second activated support) which was washed once with 500 ml of heptane at 25° C. and dried using a nitrogen purge.

Step E) is Carried Out as Follows.

A 300 ml reactor-filter flask was brought under nitrogen and 125 mL of titanium tetrachloride was added, then 5.5 g of second activated support in 15 ml of heptane was added to the reactor. The contents of the reactor were stirred for 60 minutes at room 25° C. Then, 1.78 ml of ethylbenzoate, EB (EB/Mg=0.30 molar ratio) in 4 ml of chlorobenzene was added to the reactor in 30 minutes. Temperature of reaction mixture was increased to 115° C. and then the reaction mixture was stirred at 115° C. for 90 minutes (I stage of catalyst preparation). The contents of the flask were filtered, after which the solid product was washed with chlorobenzene (125 ml) at 100 to 105° C. for 20 minutes. Then, the contents of the flask were filtered. A mixture of titanium tetrachloride (62.5 ml) and chlorobenzene (62.5 ml) was added to the reactor. The reaction mixture was stirred at 115° C. for 60 minutes (II stage of catalyst preparation). Then, the contents of the flask were filtered. A mixture of titanium tetrachloride (62.5 ml) and chlorobenzene (62.5 ml) was added to the reactor. Then, 0.51 g of 4-[benzoyl(methyl)amino]pentan-yl benzoate (AB/Mg=0.04) in 4 ml of chlorobenzene was added to the reactor in 10 minutes. The reaction mixture was stirred at 115° C. for 30 minutes (Ill stage of catalyst preparation). Then, the contents of the flask were filtered. A mixture of titanium tetrachloride (62.5 ml) and chlorobenzene (62.5 ml) was added to the reactor. The reaction mixture was stirred at 115° C. for 30 minutes (IV stage of catalyst preparation). Then, the contents of the flask were filtered. The solid product obtained was washed five times with 125 ml of heptane starting at 60° C. with 5 minutes stirring per wash prior to filtration. The temperature was gradually reduced from 60 to 25° C. during the washings. Finally, the solid product obtained was dried using a nitrogen purge at a temperature of 25° C. for 2 hours.

Polymerization was performed in a 1.8 L gas phase batch reactor.

Polymerization Method

Solutions of both the co-catalyst (triethyl aluminum (1.219M in heptane); Al/Ti=80) and the external electron donor, which include SCA and ALA for the examples and only SCA for the comparative examples (SCA: di-isopropyl dimethoxy silane (DiPDMS; 0.162M in heptane) Si/Ti=1.0) (ALA: isopropyl myristate), were added to the reactor with nitrogen-flushed pipettes at ambient temperature and ambient pressure. The amount of heptane was adjusted to be 3 ml in total. Then approx. 100 gram of propylene/hydrogen mixture (99 vol. % propylene, 1 vol. % hydrogen, viz. a 1 vol. % hydrogen pressure) was dosed to the reactor after which the reactor was heated to 50° C. A suspension of procatalyst (5 mg of a 14.6 wt. % suspension in mineral oil) mixed with approx. 5 gr of inert homo-polypropylene powder (XS-2.4 wt. %, MFI=10 g/min) was dosed to the reactor by a 16 barg liquid propylene flow. After 1 minute, the temperature and pressure were slowly increased to 70° C. and 24 barg over a period of 10 minutes. After this, all conditions were kept constant for one hour. After 1 h the reactor was vented to 15 barg within 2 minutes, the stirrer was turned off and the reactor was cooled down and vented to ambient conditions within 1-2 minutes. At ambient conditions the reactor was opened and the polymer was collected.

| | Polymerization | | | | | |
|---|---|---|---|---|---|---|
| | Temp. | | | Catalyst | | |
| | (Degrees | Al/Si | ALA/Si | Yield | | |
| Exp. | Celsius) | (mol/mol) | (mol/mol) | (kg/g) | MFI | CXS |
| CE1 | 60 | 80 | 0 | | | |
| CE2 | 70 | 80 | 0 | | | |
| CE3 | 80 | 80 | 0 | | | |
| CE4 | 60 | 7 | 0 | | | |
| CE5 | 70 | 7 | 0 | | | |
| CE6 | 80 | 7 | 0 | | | |
| 1 | 60 | 80 | 10 | | | |
| 2 | 70 | 80 | 10 | | | |
| 3 | 80 | 80 | 10 | | | |
| 4 | 60 | 80 | 1 | | | |
| 5 | 70 | 80 | 1 | | | |
| 6 | 80 | 80 | 1 | | | |
| 7 | 60 | 80 | 3 | | | |
| 8 | 70 | 80 | 3 | | | |
| 9 | 80 | 80 | 3 | | | |
| 10 | 60 | 80 | 50 | | | |
| 11 | 70 | 80 | 50 | | | |
| 12 | 80 | 80 | 50 | | | |
| 13 | 60 | 80 | 200 | | | |
| 14 | 70 | 80 | 200 | | | |
| 15 | 80 | 80 | 200 | | | |

Methods

MWD, Mn, Mw

Mw, Mn and Mz were all measured according to ASTM D6474-12 (Standard Test Method for Determining Molecular Weight Distribution and Molecular Weight Averages of Polyolefins by High Temperature Gel Permeation Chromatography). Mw stands for the weight average molecular weight and Mn stands for the number average weight. Mz stands for the z-average molecular weight.

Cold Xylene Solubles (XS)

XS, wt % is xylene solubles, measured according to ASTM D 5492-10. 1 gram of polymer and 100 ml of xylene are introduced in a glass flask equipped with a magnetic stirrer. The temperature is raised up to the boiling point of the solvent. The so obtained clear solution is then kept under reflux and stirring for further 15 min. Heating is stopped and the isolating plate between heating and flask is removed. Cooling takes places with stirring for 5 min. The closed flask is then kept for 30 min in a thermostatic water bath at 25° C. for 30 min. The so formed solid is filtered on filtering paper. 25 ml of the filtered liquid is poured in a previously weighed aluminium container, which is heated in a stove of 140° C. for at least 2 hours, under nitrogen flow and vacuum, to remove the solvent by evaporation. The container is then kept in an oven at 140° C. under vacuum until constant weight is obtained. The weight percentage of polymer soluble in xylene at room temperature is then calculated.

CXS value as used in the present description is measured using a CRYSTEX® instrument under the following protocol: 2.5 g of polymer material is placed in a 240 ml brown glass vial together with a small magnetic stirrer to be analysed by a CRYSTEX® QC machine by PolymerChar®. 200 mL of stabilized 1,2,4-trichlorobenzene (stabilizer: butyl hydroxy toluene (BHT, 300 mg per L) is used as a solvent. Dissolution of the sample, separation of the soluble from the crystalline fraction and quantification of the soluble fraction (via integrated IR detection, IR4) is done automatically by the machine. Process parameters: Dissolution temperature: 175° C., dissolution time: 60 min, injection needle temperature: 175° C., start temperature detector and oven section: 165° C., precipitation: 40° C. flow rate (elution): 3 mL/min.

Calibration of the instrument was done under the same conditions measuring the following standard samples provided by Polymer Char®:

PP-FS-H (XS 2.4%), PP-FS-R XS 7.0%), PP-FS-A (XS 11.1%), PP-FS-B (XS 16.7%), PP-FS-C (XS 32.6%).

Isotacticity

The isotacticity was measured using ¹³C NMR.

Melt Flow Rate (MFR)

For purpose of the invention the melt flow rate is the melt flow rate as measured according to ISO1133 (2.16 kg/230° C.).

1. A process for the production of a propylene homopolymer or a propylene-ethylene copolymer comprising the step of polymerizing propylene and optional ethylene comonomers in the presence of a catalyst to obtain the propylene homopolymer or the propylene-ethylene copolymer, wherein said catalyst is obtainable by a process comprising the steps of
A) providing a Ziegler-Natta procatalyst comprising contacting a magnesium-containing support with
i) a halogen-containing titanium compound,
ii) ethylbenzoate as an activator,
iii) and as internal donor an aminobenzoate compound according to formula B: 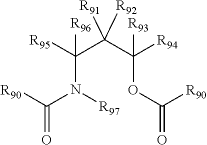
wherein each R⁹⁰ group is independently a substituted or unsubstituted aromatic group; R⁹¹, R⁹², R⁹³, R⁹⁴, R⁹⁵, and R⁹⁶ are each independently selected from a hydrogen or a linear, branched or cyclic hydrocarbyl group, selected from alkyl, alkenyl, aryl, aralkyl, or alkylaryl groups, and one or more combinations thereof; R⁹⁷ is a hydrogen or a linear, branched or cyclic hydrocarbyl group, selected from alkyl, alkenyl, aryl, aralkyl, alkoxycarbonyl or alkylaryl groups, and one or more combinations thereof; N is a nitrogen atom; O is an oxygen atom; and C is a carbon atom; and
B) contacting said Ziegler-Natta procatalyst obtained in step A) with a co-catalyst and a Selectivity Control Agent (SCA) in combination with an Activity Limiting Agent (ALA) to obtain said catalyst;
wherein the propylene homopolymer or the propylene-ethylene copolymer has an XS in the range from 2.0 to 7.0 wt %, wherein XS stands for the amount of xylene solubles which are measured according to ASTM D 5492-10.

2. The process according to claim 1, wherein the Selectivity Control Agent (SCA) is selected from the group consisting of dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, n-propyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane which is a donor, for example di(isopropyl) dimethoxysilane, and bis(perhydroisoquinolino)dimethoxysilane.

3. The process according to claim 1, wherein the Selectivity Control Agent (SCA) is selected from the group consisting of di(isopropyl) dimethoxysilane and n-propyltrimethoxysilane.

4. The process according to claim 1, wherein the Activity Limiting Agent (ALA) is selected from the group consisting of: ethyl acetate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof.

5. The process according to claim 1, wherein the Activity Limiting Agent (ALA) is iso-propyl myristate.

6. The process according to claim 1, wherein the SCA/ALA ratio is from 0.010 to 100.

7. The process according to claim 1, wherein the process is a gas phase polymerization process.

8. The process according to claim 1, wherein the process of the invention is performed in at least one horizontal and/or vertical gas phase reactor.

9. The process according to claim 1, wherein the process occurs in a horizontal or a vertical gas phase reactor, the reactor can be mechanically stirred.

10. The process according to claim 1, wherein the process is phthalate free and/or wherein the process is free of 9,9-bis(methoxymethyl)fluorene.

11. A propylene homopolymer or propylene-ethylene copolymer obtained or obtainable by the process of claim 1.

12. A biaxially oriented polypropylene (BOPP) film comprising the propylene homopolymer or propylene-ethylene copolymer of claim 11.

13. The process according to claim 1, wherein step A) to provide the Ziegler-Natta procatalyst comprises the following steps:
i) contacting a compound R⁴_{z}MgX⁴_{2-z} with an alkoxy- or aryloxy-containing silane compound to give a first intermediate reaction product, being a solid Mg(OR¹)ₓX¹₂₋ₓ, wherein: R⁴ and R¹ are each a linear, branched or cyclic hydrocarbyl group independently selected from alkyl, alkenyl, aryl, aralkyl, alkoxycarbonyl or alkylaryl groups, and one or more combinations thereof, wherein said hydrocarbyl group may be substituted or unsubstituted, may contain one or more heteroatoms; X⁴ and X¹ are each independently selected from the group of consisting of fluoride (F−), chloride (Cl−), bromide (Br−) or iodide (I−); z is in a range of larger than 0 and smaller than 2, being 0<z<2, x is in a range of larger than 0 and smaller than 2, being 0<x<2;
ii) optionally contacting the solid Mg(OR¹)ₓX¹₂₋ₓ obtained in step ii) with at least one activating compound selected from the group formed of activating electron donors and metal alkoxide compounds of formula M¹(OR²)_{v-w}(OR³)_{w} or M²(OR²)_{v-w}(R³)_{w}, to obtain a second intermediate product; wherein M¹ is a metal selected from the group consisting of Ti, Zr, Hf, Al or Si; M² is a metal being Si; v is the valency of M¹ or M² and is either 3 or 4; w<v; R² and R³ are each a linear, branched or cyclic hydrocarbyl group independently selected from alkyl, alkenyl, aryl, aralkyl, alkoxycarbonyl or alkylaryl groups, and one or more combinations thereof, wherein said hydrocarbyl group may be substituted or unsubstituted, may contain one or more heteroatoms;
iii) contacting the first or second intermediate reaction product, obtained respectively in step i) or ii), with the halogen-containing Ti-compound; the activator; and
the internal electron donor
to obtain said Ziegler-Natta procatalyst.

14. The process according to claim 1, wherein aminobenzoate compound according to formula B is 4-[benzoyl(methyl)amino]pentan-2-yl benzoate (AB).
